(19) United States
(12) Patent Application Publication
(10) Pub. No.: US 2011/0229036 A1
(43) Pub. Date: Sep. 22, 2011

(54) METHOD AND APPARATUS FOR TEXT AND ERROR PROFILING OF HISTORICAL DOCUMENTS

(75) Inventors: Ulrich Reffle, Munich (DE); Klaus U. Schulz, Holzkirchen (DE); Annette Gotscharek, Groebenzell (DE); Christoph Ringlstetter, Munich (DE)

(73) Assignee: LUDWIG-MAXIMILIANS-UNIVERSITAT MUNCHEN, Munchen (DE)

(21) Appl. No.: 12/725,767

(22) Filed: Mar. 17, 2010

(51) Int. Cl. G06K 9/18

(52) U.S. Cl. 382/182

(57) ABSTRACT

The present invention enables the computation of various types of information for a particular scanned and OCR recognised or retyped historical input document. It provides a global view on the “patterns” for historical language variation (text profiling) and the OCR errors most frequently found in the text (error profiling). For each of the individual tokens of the OCR output, an interpretation is given which based on the document specific information attempts to describe both, the underlying correct word of the text and the corresponding modern spelling of the word. This not only provides input for optimised OCR recognition of historical documents, but also for quality assurance and improved information retrieval.

### BACKGROUND OF THE INVENTION

1. Field of the Invention

The present invention relates to profiling historical input documents recognized by optical character recognition (OCR), in particular, in terms of their language and in terms of the errors introduced by imperfect OCR.

2. Description of the Related Art

Many organisations are currently engaged in mass digitization projects that aim to make historical documents and corpora online available in the Internet. In the process of digitization of such historical documents, after collecting and processing the electronic image representation, OCR systems are used. Depending on the quality of the image and linguistic difficulty of the document processed, the results are useable, partially-usable or unusable for the subsequent processing and presentation of the texts.

For historical documents especially, the results of available OCR solutions are still unsatisfactory. This is due to a lack of accurate information about the linguistic peculiarities, such as historical versions of modern words, and the specific detection of problems of the processed document such as systematic recognition errors on document-specific historical fonts among other difficulties related to poor quality of paper, ink, printing. Modern spelling is considered to be the writing of a given word in accordance with a standard in common use at the current time. In contrast, historic spelling is considered to constitute the spelling of the word in accordance with a previous standard corresponding to a time prior to implementation of the current standard.

In view of the informational access to digitised historical documents, historical variants pose a problem for the user that, if the system fails to make a correct assignment of the modern spelling of a scanned historical word, the user then has to enter all historical variants of a modern word when making a search query. Thus, the matching process between queries submitted to search engines and variants of the search terms found in historical documents needs special support since a significant amount of the vocabulary is not found in a dictionary of modern language.

Appropriate lexical resources such as dictionaries play an important role in improving OCR recognition of historical documents. For instance, special historical dictionaries, which comprise an existing collection of historical variants, may improve recognition. Such dictionaries may comprise a set of historical rewrite patterns which link the scanned historical word with the modern spelling thereof.

However, overcoming the aforementioned problems still tends to present difficulties since another relevant factor is the historical point in time when documents were created, which may be unknown. This creates the need for a solution that is not static and tied to a particular historical period, but rather enables the flexibility to respond to a particular historical input document, with all its respective peculiarities.

### SUMMARY OF THE INVENTION

The present invention solves these problems by providing a method and apparatus for conducting text and error profiling of the document. Such profiling comprises obtaining information specific to the input document.

However, when profiling of historical variants and OCR errors in historical documents, there is a danger that certain OCR recognition errors are treated as historical variants and the other way round. This causes the problem of distinguishing between historical variants and such OCR errors. For example, if the text profile erroneously characterizes OCR errors as historical language variants, then the adaptation of the OCR (or the post-correction system) will be misled. As a result, the accuracy decreases. It is therefore desirable to spot recognition errors that are prone to be mistaken for variants automatically.

Therefore, the present invention also provides a solution that improves the accuracy and efficiency of the profiling of such historic documents.

The present invention is recited by the features of the independent claims, whereas advantageous embodiments thereof are recited by the additional features of the dependent claims.

In general, the present invention provides quality assurance and optimised OCR recognition and improved information retrieval (IR) from the digitised historical documents through profiling.

According to one aspect of the present invention, the profiling performed involves processing various types of information for a historical input document in order to provide patterns for historical language variation (text profiling) and the OCR errors most frequently found in the text (error profiling).

Such profiling comprises a language part, wherein information on the kind of historical orthographic variants used in the input text is provided. This means that a number of rewrite “patterns” are specified. Such patterns explain the difference between the “modern” spelling of a word e.g., German “Kurfürstliche” and a “historic” spelling of the same word found in the text e.g., “Churfürstliche”. For the language part of the profiling, the difference between these modern and historic spelling variants is characterized in terms of patterns which represent the association between the historic spelling of the word along with its modern spelling, in the above example K→Ch.

In addition to the language part, the profiling performed according to the present invention also comprises an error profiling part, which estimates the probabilities of recognition errors that occurred during the OCR of the document. The error profiling part also comprises patterns, which explain the differences between the output of an OCR engine and a candidate word in terms of OCR operations. An example of this is C→L, wherein the actual word was mistakenly recognised by the OCR engine as Lhurfürstliche instead of Churfürstliche.

The output of an OCR engine consists of “OCR tokens” which may be an electronic text representation of a word scanned from an input document. The aim of text and error profiling according to the present invention is to find the OCR tokens output by the OCR and “guess” the correct word interpretation of each token in an automated way, and to subsequently derive a ranked list of historical patterns and recognition errors specific to the text of the input document based on the interpretation. In practice, the “guess” will not always be correct, however, inexact and partial profiles may be used to derive models for the historical language used in the document and the OCR channel that help to optimise adaptive OCR or to improve post-correction of the OCR output.

According to the invention, a historical OCR document is considered as a sequence of observed words. The main information structure for profiling is a set of candidate interpretations for each input term. As described above, a single interpretation of an observed OCR token, w_{ocr} comprises:
1. An OCR error part, which represents the transformation of a historical candidate word w_{cand} to w_{ocr}, by zero, one, or more OCR patterns (e.g. C_L); and
2. A language part, which represents the transformation of a modern base-word w_{mod} to the historical candidate w_{cand} by zero, one, or more historical variant patterns (e.g. K_Ch).

An example for the notation of one candidate interpretation for the OCR token w_{ocr}=Lhurfürstliche is the modern base-word Kurfürstliche, which is transformed to the candidate word Churfürstliche by a historical transformation instruction (the single pattern K_Ch) whereby, due to the OCR error pattern C_L, the word has been erroneously recognised as Lhurfürstliche. This can be expressed as follows:

$${Kurfürstliche}_{{w}_{mod}} {\to }^{hist : K \_ Ch} {Churfürstliche}_{{w}_{cand}} {\to }^{ocr : C \_ L} {Lhurfürstliche}_{{w}_{ocr}}$$

As shown above, the present invention thus determines interpretations of an OCR token as quintuples of information comprising w_{mod}, w_{cand}, w_{ocr}, the historic transformation (the pattern K_Ch) and the ocr transformation (the pattern C_L). Each interpretation has a certain probability determined by initial models for the language and error parts. For subsequent applications all five parts of information comprised in the interpretations are required.

In other words, according to the present invention a probability distribution of historical language patterns and OCR error patterns for a certain input document is determined, and the probabilities of historical rewrite patterns which represent historical spelling variants, and probabilities for OCR edit operations which represent OCR errors, are output.

This output profiling information may subsequently be provided to applications such as adaptive OCR or OCR post-correction in order to optimise their functions in terms of efficiency and accuracy. In contrast to the prior art, the method of the present invention deals with both historical language and OCR error phenomena and separates them from one another.

For a given input text the present invention may output four kinds of (profile) information: not only the base language of the input text, and a list indicating what kind of supported foreign language expressions occur in the text, but also a ranked list of historical rewrite patterns, each with a probability, as shown in FIG. 4, a ranked list of OCR error patterns, each with a probability as shown in FIG. 5, and a global quality measure estimated from: the number of errors, words recognized as correct, word recognized as destroyed and the number of unknown words. This quality measure gives an indication if the recognition process was at least acceptable i.e. conforms with accepted values.

In this regard, the present invention distinguishes itself through automatic recognition of document centric error patterns, which, until now, has never been developed to the point that it could be used professionally. In particular, the simultaneous recognition of historical rewrite patterns and error patterns combined with their respective automatic categorisation and separation is unknown.

According to another aspect of the invention, the initial models may be tuned during several rounds by an unsupervised learning approach until they stabilise.

Generally known font training approaches implemented in some OCR systems enable the validation of parts of the document, via a user interface, to adapt the classifier to the font (supervised learning) but do so without taking into account the language specifics. In contrast, as illustrated by the example above, the present invention provides an improved method that may be executed fully automatically without any user interaction (unsupervised learning).

In a preferred embodiment, an indexing connection between the historical word and its modern spelling variant is made. This advantageously ensures that any search queries formulated with the modern spelling variant nevertheless lead to relevant matches in historical documents where the historical word has been used.

### BRIEF DESCRIPTION OF THE DRAWINGS

FIG. 1. is a flow diagram of the method steps according to an embodiment of the present invention.

FIG. 2 is a flow diagram showing an example of the present invention involving actual OCR tokens derived from a scanned historical input document.

FIG. 3 shows an example of profiling of an OCR recognised document according to the present invention.

FIG. 4 shows historical patterns, probability and absolute counts as recognized according to the present invention in the OCR document as compared to actual numbers derived from a ground truth i.e. keyed/manually typed version of the original document.

FIG. 5 shows OCR patterns, probability and absolute counts as recognized according to the present invention in the OCR document and actual numbers derived from a ground truth i.e. keyed version of the original document.

FIG. 6 shows an example of an interpretation, according to an embodiment of the present invention, after the eighth iteration of an OCR recognised word that contains a historical pattern as well as an OCR error: leugnen→läugnen→läugncn.

### DETAILED DESCRIPTION

According to the present invention, there is provided a method and apparatus for profiling historical variants of words and OCR errors obtained from the output of an optical character recognition engine.

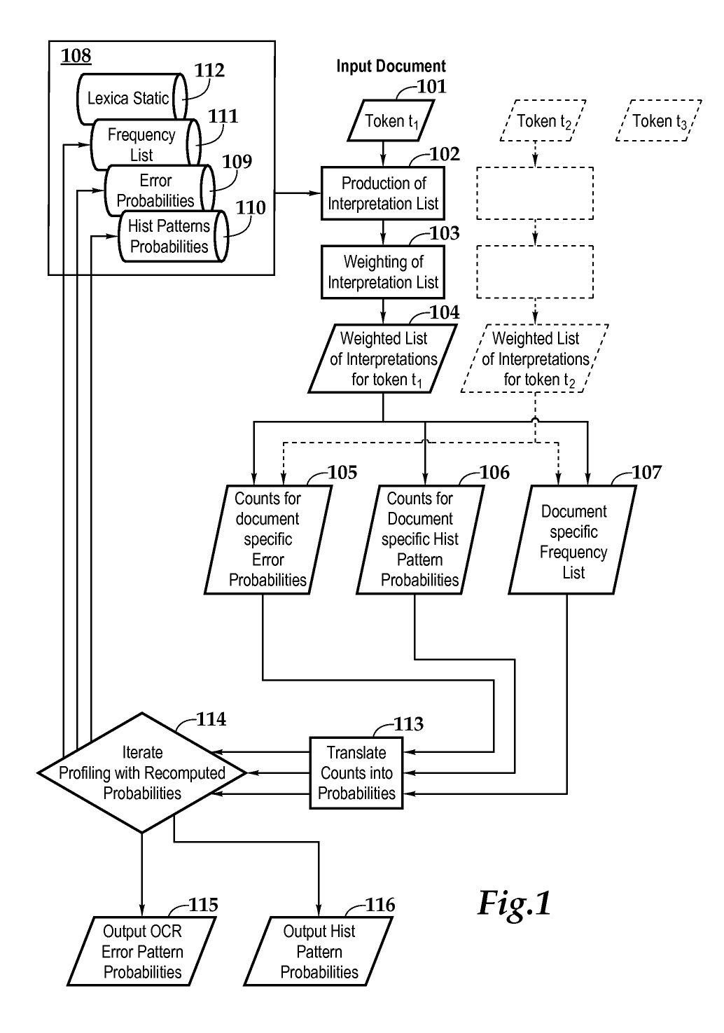

The invention assumes that an input document contains historical language. As shown in the example of FIG. 1, the OCR engine outputs a set of “tokens” 101 (t1, t2, t3 etc.) denoted by W_{ocr}. Essentially, a token w_{ocr} corresponds to a unique word in the actual text of the historical input document. In general the actual word is not known, but is rather “guessed” from a list of potential candidates each denoted by w_{cand}. This relationship can be expressed as an OCR-trace comprising T_{ocr}, which states the type of OCR errors occurred in addition to their location in w_{cand}, thereby resulting in w_{ocr}. The notation refers to a guessed relationship i.e. wherein a token is matched with a candidate.

$${w}_{cand} {\to }^{{T}_{ocr}} {w}_{ocr}$$

Since the OCR input document contains historical language, an actual word in the text of the document will often correspond to a word w_{mod} of modern language. Furthermore, there are sometimes several modern words w_{mod} that “might” correspond to the actual word. These associations between a historical spelling and a modern spelling of a word can be described in terms of a transformation Tₕᵢₛₜ, which states the derivation of the actual word from w_{mod}. This relationship may be expressed as hist-trace, which lists rewrite “patterns” and the positions where they have been applied. Using similar notational conventions as above, the processes may be written as:

$${w}_{mod} {\to }^{{T}_{hist}} {w}_{cand}$$

In a next step, the present invention determines a list of candidate interpretations 102 for each of the tokens 101. These represent a potential set of words, which correspond to the actual words in the original text. In terms of the aforementioned notional conventions, a candidate interpretation of a token W_{ocr} of the OCR output can be considered as a quintuple i.e. five pieces of information, as described above, wherein the combination of both the OCR error and historical rewrite patterns are expressed as:

$${w}_{mod} {\to }^{{T}_{hist}} {w}_{cand} {\to }^{{T}_{ocr}} {w}_{ocr}$$

and wherein w_{cand} represents a candidate for the ground truth version of w_{ocr}; w_{mod} is a modern word that might correspond to w_{cand}; Tₕᵢₛₜ is a hist-trace, and T_{ocr}, is an ocr-trace.

In a next step, a weighting (value) is assigned 103 to each of the candidate interpretations. The weighting value that is assigned to each interpretation may be considered a probability value, between zero and one, which can be used to quantify the likelihood of the interpretation corresponding to the actual word in the input document. This weighting value is derived from the combined respective probabilities for the modern base-word and all historical patterns and OCR error patterns involved in the interpretation.

This list of weighted candidate interpretations 104 is then ranked according to their individual assigned weightings for each token. This enables the top ranked interpretations for each respective token to be ascertained. The combined totals of this ranking information are then used as the basis for generating information specific to the input document.

The document-specific information generated comprises a “count” of the total weighting values for: OCR error pattern probabilities 105, historical pattern probabilities 106 and frequencies of modern words 107 associated with the count of both of these probabilities. In the sense of the present invention, the count refers to the cumulative value of each pattern for all tokens, based on the weightings assigned to them.

The document-specific information can subsequently be translated into probabilities 113 and used to determine a set of probabilities of OCR error patterns specific to the document wherein each error comes with a probability value and an absolute value. For example, the probability value of an error of the form m→rn represents the likelihood that, if the letter m occurs in the actual text of the input document, it will be recognised as rn by the OCR engine. The absolute value denotes how often the OCR error occurs.

Furthermore, the translated document-specific information 113 may also be used to determine a set of probabilities of historical patterns wherein each historical pattern comes with a probability value and an absolute value. For example, the probability value of a pattern of the form t→th represents the likelihood that, if the string t occurs in the modernized spelling of a word of the text, it will be spelled as th in the historical spelling found in the text. The absolute value denotes how often a string t in a modern spelling of a word of the input text is written th in the historical spelling found in the text.

Furthermore, a document specific frequency list 107 is computed from the respective modern base words w_{mod}, which are involved in each interpretation. The base words are counted according to the weight of their respective interpretation. After all tokens of the document are processed, each modern base word comes with a document-specific probability value 113 translated from the counts.

This document-specific information can subsequently be output, as shown in 115 and 116, and used for automatic or interactive correction. For example, the information may be used by the OCR system for automatic correction, or also provided to a user interface, which suggests potential candidate words to the user. This improves the likelihood of a candidate word being the actual word, and hence optimises the efficiency of the text user verification process.

In a preferred embodiment of the present invention, the list of candidate interpretations 102 is determined using a static lexicon 112 (212). This may constitute a language dictionary as previously mentioned. Furthermore, according to this embodiment, the list of candidate interpretations is further determined using global information 108. This global information forms the aforementioned models, which comprise initial values. Such global information may comprise a frequency list 111 of modern words in the document, probabilities of OCR error patterns 109 and probabilities of historical patterns 110. By basing the determination the list of candidate interpretations using such global information, the present invention enables output of specific information with regard to a particular input document, whereby accurate information and the source of the document may initially be unknown.

In a further preferred embodiment, the aforementioned method steps are performed iteratively 114, wherein, after the first iteration, the generated document-specific information is used for determining the list of candidate interpretations. This enables the present invention to output information specific to the input document, thereby improving the probability that correct interpretations will ultimately be assigned to the OCR tokens representing historical words.

In another preferred embodiment, the aforementioned method steps are performed iteratively 114, wherein, after the first iteration, the generated document-specific information is used to update the global information 108. This enables the present invention to continuously provide feedback and update the global information thereby effectively tailoring the information to the specific input document, thereby dynamically improving the probability that correct interpretations will ultimately be assigned to the OCR tokens representing historical words.

In yet another preferred embodiment, the OCR token is indexed with spelling variants of at least one word or word fragment wherein the indexing is based on the document-specific information generated by at least one or more iterations of the method of the present invention, for each token. Such indexing may advantageously reduce time-consuming user interaction with OCR post correction systems through automatically correcting the word. Furthermore, such indexing may ensure improved flexibility and accuracy in future search queries, whereby a user may enter one of a plurality of spelling variations for a historical word, and obtain the correct independent of which spelling entered. Since the user is often unaware of all the variants that exist, this may advantageously improve recall when searching historical documents.

For example, historical documents may be linked with users in an Information Retrieval environment wherein the modern language search query token is supplemented with at least one word or word fragment from a lexicon based on said document-specific information or the generated document-specific information to trigger an Information Retrieval System.

According to a further embodiment, the present invention enables the measuring of the quality of the OCR output based on the document-specific information. The output of the present invention is a profile specific to a historical document, which represents an estimation of the historical patterns and OCR patterns in the actual document. This profile may subsequently be used to generate information to ascertain how well an internal quality system of an OCR engine matches reality. This may be achieved by comparison of a version of the document with confidence values for each character with the output profile. This may result in a reduction of “suspicious characters” of the OCR quality system where the characters do not match a profile and a designation of suspicious characters where they do match a profile.

### Example of Implementation

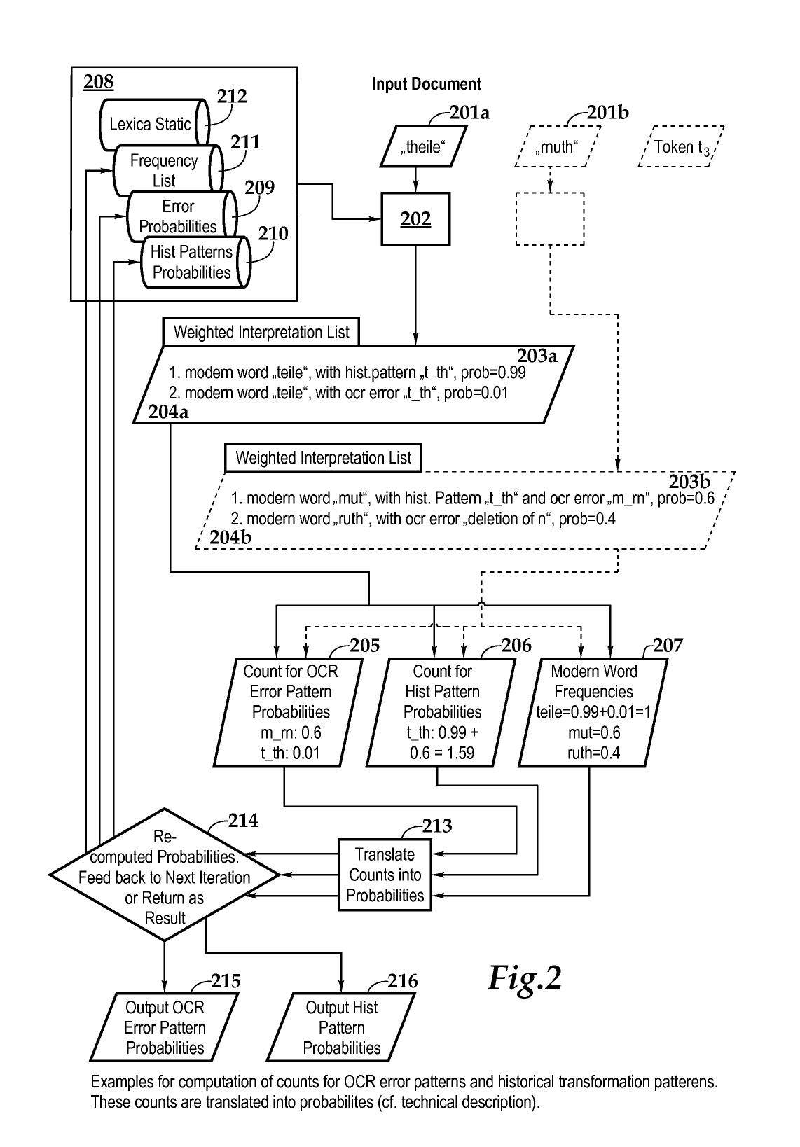

In an example of an embodiment of the present invention according to FIG. 2, following an initialisation, or first iteration, of the probabilistic distribution of the historical patterns, the vocabulary basis, and the initialisation of OCR patterns, a further iterative process of adaptation to the specifics of the profiled document may be performed.

Static Resources: In an initial offline step static global input probabilities for modern base words, global probabilities for historical transformation patterns and global probabilities for OCR error patterns have to be determined which later on will be used for the initialisation of the present invention as global information 209, 210, 211. These resources 209, 210, 211 may be updated into document specific information by the present invention.

Global probabilities for modern base words and global probabilities for historical transformation patterns are estimated form a large ground-truth corpus of historical documents i.e. a large set of texts which may be used to conduct statistical analysis, checking occurrences or validating linguistic rules, from hereon referred to as a static historical corpus. As previously mentioned, historical interpretations are generated in a way, that historical words are matched with modern words using a minimal number of historical transformation patterns.

The global probabilities for historical patterns are estimated from the interpretations that explain the historical variants emerging in the static historical corpus. If, for example, n(patᵢ,1) denotes the number of applications of pattern patᵢ in the historical corpus, and n(patᵢ,0) denotes the number of occurrences of the left hand side of the rewrite pattern where the right hand side was not applied, the probability can be estimated as follows:

P(patᵢ)=n(patᵢ,1)/(n(patᵢ,1)+n(patᵢ,0)).

The probabilities of the modern words for the global frequency list 211 are estimated from the interpretations determined for the static historical corpus. This number is then divided by the number of running words (tokens) of the corpus. A set of candidate interpretations may be determined by a variant finite state automaton, wherein said determination may be performed sequentially for each token in the historical corpus. Input of the automaton may be, for example, a list of historical transformation patterns (e.g. for German) and a set of active and passive input lexica. An active lexicon is used to generate interpretations applying one or more patterns, whereas a passive lexicon is only allowed to generate interpretations with an “empty” pattern, empty meaning that zero transformations are required to transform the token into a candidate word, i.e. no patterns are applied and the lexicon is used for simple lookup.

For the computation of the static probabilities used for the subsequent initialisation of the method, only the top-ranked interpretation is used. Two lists are stored: the frequency list of the used modern base words and that of the relative frequencies of the historical transformation patterns as an estimate for their probabilities. Unseen modern words may be assigned with a heuristic value. In another embodiment according to this example, a part of the probability mass may be held out to estimate unseen modern words during runtime (smoothing).

The static probabilities of OCR errors used for initialisation of the present invention are assumed to be identical for each operation or estimated from OCR material.

Initialisation: Initialisation according to the present invention corresponds to the first round or iteration of the claimed method steps, which uses the global values 208 for the probabilities of modern base words 211, historical transformation patterns 210 and OCR error patterns 209, as starting probabilities. The probabilities for historical patterns 206 and OCR patterns 205 are estimated from the interpretations that explain the observed tokens 201 of the document being profiled according to the present invention.

The probabilities of the modern words 207 are estimated from the interpretations determined for the input document in the previous iteration. This number is then divided by the number of running words (tokens) of the document. A set of candidate interpretations 203a and 203b may be determined by a variant finite state automaton, wherein said determination may be performed sequentially for each token in the historical input document. As mentioned before, the input of the automaton is, for example, a list of historical transformation patterns (e.g. for German) and a set of active and passive input lexica.

From the set of candidate interpretations 203a and 203b each interpretation is ranked for each token as shown in 204a and 204b, and subsequently counted according to its probability as determined by the input lists 209, 210, 211. The counted results are shown in references 205, 206 and 207.

In the example in FIG. 2, the input tokens “theile” 201a and “rmuth” 201b are shown. As previously described, based on the global information 208, an interpretation list is determined 202, weighted 203 and ranked 204. For example, the top-ranked interpretation for OCR token “theile” 201a is the modern word “teile” weighted with the value 0.99 indicative of the probability of the historical pattern “t_th” being applied. The second ranked interpretation is also the modern word “teile” weighted with the value 0.01 indicative of the probability of the OCR error pattern “t_th” being applied. For the next OCR token “rnuth” 201b the top-ranked interpretation is the modern word “mut” weighted with the value 0.6 indicative of the probability of the historical pattern “t_th” in addition to the OCR error “m_rn” being applied. The second ranked interpretation is the modern word “ruth” weighted with the value 0.4, indicative of the probability of the OCR error pattern “deletion of n” being applied. The results of these error patterns are counted as shown in 205, 206 and 207. These counted results may also be ranked.

For example, the count for OCR error pattern probabilities 205 shows, on the basis of the input of the two tokens 201a and 201b, that the top ranked OCR error pattern is “m_rn” with the probability value of 0.6 (derived from the weighted interpretation list 203b for token 201b), and the second ranked OCR error pattern is “t_th” with the probability of 0.01 (derived from the weighted interpretation list 203a for token 201a). Further, the count for historical pattern probabilities 206 shows, on the basis of both input tokens, that the top ranked historical pattern is “t_th” with the cumulative probability value of 1.59 (derived from the weighted interpretation lists 203a and 203b for both tokens 201a and 201b) i.e. the total of the weighted values that the historical pattern “t_th” is applied in the case of both tokens (0.99+0.6).

The frequency list count 207 shows, on the basis of both input tokens, that the top ranked modern word is “teile” in view of the total probability of the OCR error pattern “t_th” and the historical pattern “t_th”. The value of the frequency of this word in the input document is 1, which is derived from the weighted interpretation lists 203a and 203b for both tokens 201a and 201b and corresponds to the total of the weighted values that both the OCR error and historical pattern “t_th” is applied in the case of both tokens (0.99+0.01) when said patterns are associated with the word “teile”.

At the end of each iteration i.e. after having processed the lists of interpretations for all input tokens, the computation of the document specific probabilities corresponds to the computation of the global probabilities 213. Again, if, for example, n(patᵢ,1) denotes the number of applications of pattern patᵢ in the historical input document, and n(patᵢ,0) denotes the number of occurrences of the left hand side of the rewrite pattern where the right hand side was not applied, the probability can be estimated as follows:

P(patᵢ)=n(patᵢ,1)/(n(patᵢ,1)+n(patᵢ,0)).

The following table shows a further example of how the respective probabilities may be determined in the case of the input OCR token sentence: “dieser monn verdint drei tnaler”

| | Tₕᵢₛₜ | | T_{ocr} | | | relevant |
|---|---|---|---|---|---|---|
| | hist- | | ocr- | | | increments |
| W_{mod} | trace | W_{cand} | trace | W_{ocr} | prob. | (selection) |
| dieser | — | dieser | — | dieser | 1 | nₕᵢₛₜ(ie_i, 0) += 1, |
| | | | | | | n_{ocr}(ie_i, 0) += 1 |
| mann | — | mann | [a_o] | monn | 0.65 | n_{ocr}(a_o, 1) += |
| | | | | | | 0.65, |
| | | | | | | n_{ocr}(n_nn, 0) += |
| | | | | | | 0.65, |
| | | | | | | n_{ocr}(n_nn, 0) += |
| | | | | | | 0.65 |
| mond | — | mond | [d_n] | | 0.12 | n_{ocr}(d_n, 1) += |
| | | | | | | 0.12, |
| | | | | | | n_{ocr}(n_nn, 0) += |
| | | | | | | 0.12 |
| mohn | [oh_o] | mon | [n_nn] | | 0.15 | nₕᵢₛₜ(oh_o, 1) += |
| | | | | | | 0.15, |
| | | | | | | n_{ocr}(n_nn, 1) += |
| | | | | | | 0.15 |
| mohn | — | mohn | [h_n] | | 0.08 | n_{ocr}(h_n, 1) += |
| | | | | | | 0.08 |
| verdient | [ie_i] | verdint | — | verdint | 0.80 | nₕᵢₛₜ(ie_i, 1) += |
| | | | | | | 0.80 |
| | | | | | | nₕᵢₛₜ(t_th, 0) += |
| | | | | | | 0.80 |
| verdient | — | verdient | [ie_i] | | 0.20 | n_{ocr}(ie_i, 1) += |
| | | | | | | 0.20, |
| | | | | | | nₕᵢₛₜ(ie_i, 1) += |
| | | | | | | 0.20, |
| | | | | | | nₕᵢₛₜ(t_th, 0) += |
| | | | | | | 0.80 |
| drei | — | drei | — | drei | 1 | n_{ocr}(d_n, 0) += 1, |
| taler | [t_th] | thaler | [h_n] | tnaler | 0.6 | nₕᵢₛₜ(t_th, 1) += |
| | | | | | | 0.6, |
| | | | | | | n_{ocr}(h_n, 1) += |
| | | | | | | 0.6, |
| | | | | | | n_{ocr}(a_o, 0) += |
| | | | | | | 0.6 |
| maler | — | maler | [m_tn] | | 0.4 | n_{ocr}(m_tn, 1) += |
| | | | | | | 0.4, |
| | | | | | | n_{ocr}(a_o, 0) += |
| | | | | | | 0.6 |

“n(x_y,1)+=0.42” means that the count is increased by 0.42 for that particular pattern
nₕᵢₛₜ(ie_i,1) denotes the accumulated probabilities where the historical variant pattern ie_i was detected. nₕᵢₛₜ(ie_i,0) denotes the accumulated probabilities where the pattern would be applicable but was not applied (“ie” is in w_{mod} but was not changed to “i”). In the example above, not all increments of this second kind are listed.

As explained above, the probabilities for variant patterns and ocr error patterns can be computed in the following way:

P(patᵢ)=n(patᵢ,1)/n(patᵢ,1)+n(patᵢ,0)

For example, the probability of the historical transformation pattern of t_th occurring in the document is: P(t_th)=0.6/0.6+1.6=0.273. As mentioned above, this document-specific information can subsequently be output, as shown in 215 and 216, and used for automatic or interactive correction.

In a preferred embodiment, the present invention may be performed as an iterative process 214. Subsequent to the probabilities having been initialised and the probability values derived, as described above, further iterations enable adaptation of the global reference information 208 in order to approximate the optimal settings for the input document. The probabilities may be iteratively modified using a variant of the expectation maximization strategy.

According to one implementation, the probabilities of the OCR patterns are recomputed wherein the probability mass of all interpretations with a certain OCR pattern involved is accumulated. The adapted probability of the error pattern is subsequently estimated through division of their accumulated count by the sum of occurrences of the left hand side of the pattern in the historical candidates of the interpretations W_{cand}. This results in an estimate of how often a certain character sequence occurred and how often it was transformed by an OCR error into a certain different character sequence.

According to another implementation, the probabilities of the historical patterns are recomputed wherein, for each round of iteration, the probability mass of all interpretations involving a certain historical pattern is accumulated. The probability of each historical pattern is then computed as the quotient between this accumulation and the sum of occurrences of the left hand side of the pattern in the candidates of the modern words w_{mod}.

According to another implementation, the probabilities of the modern words are recomputed wherein the probability mass of all interpretations for which a certain modern word w_{mod} is involved, is thereby accumulated. The adapted probability of the modern word then is estimated as the quotient of this accumulated probabilities divided by the number of all tokens in the document.

Several parameters may control the adaptation of the probability function P during the iterations. Subsequent to each iteration, the present invention collects values n(pat,0), n(pat,1) for all patterns that emerge in the historical input document. During the iterative process, the estimates of the probabilities no longer follow the initial lists obtained from the global information, but rather the accumulated knowledge from the predictions for each token of the previous rounds of iteration. Since each token comes with a list of interpretations, with no secure knowledge which of them is the correct one, each individual interpretation associated with each individual token contributes with its estimated probability mass to the numerators, as shown in FIG. 2. The computation is realised with the same formulae applied to the initialisations.

In another implementation of the invention, the update of a pattern may be cut off wherein P(pat_hist) respectively P(pat_ocr) are only then updated if n(pat,1), the number of occurrences of the rewrite pattern, exceeds a certain threshold frequency relative to the text length. Furthermore, according to this implementation, different thresholds are used for OCR and historical patterns. This may increase the overall accuracy in that only important patterns are kept.

If, during an iteration, a pattern is eliminated through the cut-off from the profiling, its contribution to the probability mass can either be kept at its value of the previous round or its probability can be set to zero. An alternative is to assign a heuristic smoothing value to the pattern. Such a heuristic smoothing value may be computed from a held out part of the probability mass.

According to a further implementation iterative method for the adaptation of the historical pattern set, the assigned probabilities and the ranking of the local predictions, may terminate either after reaching stable values or after exceeding a predefined number of iterations. The method according to the present invention offers the benefit of converging against stable values.

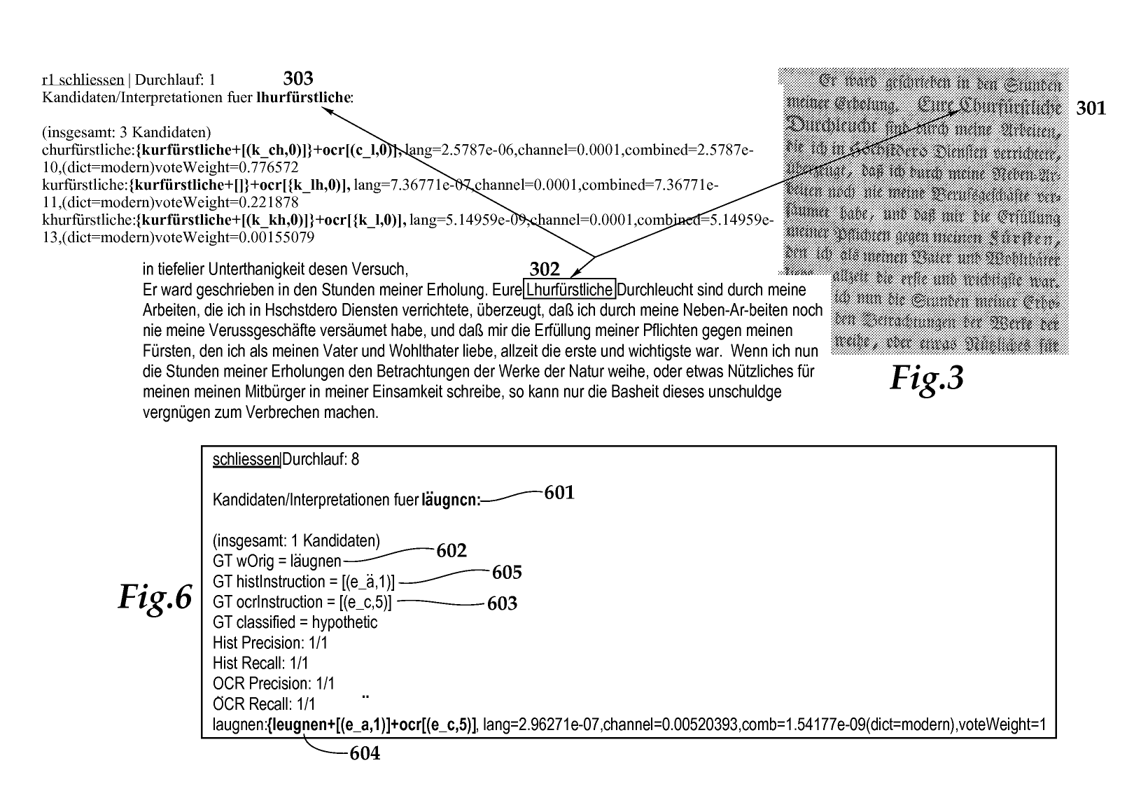

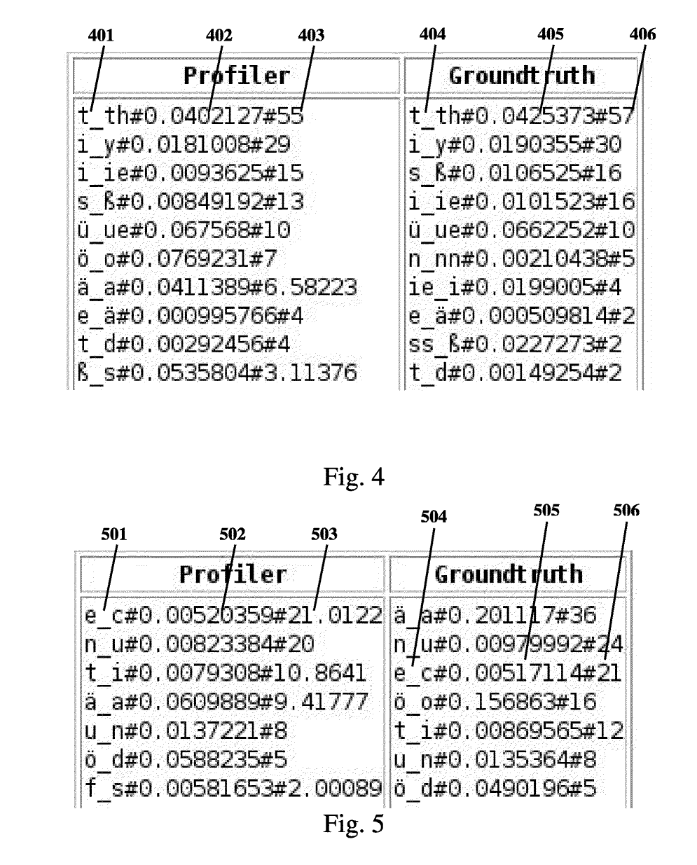

The invention thereby advantageously achieves industrially exploitable results. For both historical patterns and OCR patterns, the profiling according to the present invention provides results that significantly improve the digitisation of historical documents. FIG. 3, as previously described, shows an example of profiling of an OCR recognised document according to the present invention with respect to the OCR token “Lhurfürstliche” 302. This token is obtained by OCR of an actual word “Churfürstliche” from the historical input document 301, wherein three candidate interpretations are determined 303 through implementation of the present invention. Further, FIG. 4 shows historical patterns in terms of their probability and absolute counts as recognized according to the present invention in the OCR document as compared to actual numbers derived from a ground truth i.e. keyed/manually typed version of the original document. For example, for the specific input document, the historical pattern “t_th” 401 has an estimated probability 402 of 0.0402127 and an estimated frequency 403 of 55 occurrences, as determined according to the present invention. This is extremely close to the actual values for “t_th” 404, which has an actual probability 405 of 0.0425373, and an actual frequency 406 of 57 occurrences. Similarly, FIG. 5 shows OCR error patterns, probability and absolute counts as recognized according to the present invention in the OCR document and actual numbers derived from a ground truth i.e. keyed version of the original document. For example, for the specific input document, the OCR error pattern “e_c” 501 has an estimated probability 502 of 0.00520359 and an estimated frequency 503 of 21.0122 occurrences, as determined according to the present invention. This is also extremely close to the actual OCR error values for “e_c” 504, which has an actual probability 505 of 0.00517114 and an actual frequency 506 of 21 occurrences.

In particular, the present invention enables the accurate and efficient processing of strings that contain both OCR errors and historical patterns as shown in FIGS. 3 (described above) and 6, wherein the interpretation is leugnen→läugnen→läugncn and w_{ocr}=läugncn 601, w_{cand}=läugnen 602 with T_{ocr}=e_c 603, and w_{mod}=leugnen 604, with Tₕᵢₛₜ=e_ä 605. Such processing could not be properly achieved with any other established approach. Also, in contrast to the prior art, the present invention achieves optimised convergence to stable probabilities e.g. after a maximum of 10 iterations for both error patterns as well as for historical patterns, thus improving the efficiency of such profiling.

The architecture of the present invention is modular in the sense that recognition mechanisms for base languages can be integrated in a simple way, provided that appropriate language resources are available. For a new language, a full form dictionary with frequency information and a set of historical rewrite patterns for its respective orthographic variants in history may be provided. A supplementary historical dictionary may be used to improve accuracy. The recognition of foreign language expressions may be flexible and generic in the sense that further new dictionaries can be added in a standardized way. A user of the present invention may additionally provide suitable dictionaries of foreign language expressions to improve accuracy.

It will be understood by the skilled person that the present invention may be implemented with OCR tokens from scanned documents as well as retyped documents i.e. wherein the token text is entered manually.

The present invention may include a simple to use, well-defined application program interface (API) and an additional XML output factory.

The input text may be available as plain text (utf-8) format, wherein an XML format may be specified, and an XML interface using recognition confidence and spatial information may be implemented. Available meta-data, such as the year of publication of the input document, may then be used to improve the profiling. The present invention may be implemented as software provided as part of a collection of C++-modules but may also be implemented in any other suitable programming language, offering the output as an answer-aggregate of a specified type, or as XML string.

The present invention may be implemented for use on LINUX systems, however, it may also be supported by a Windows or any other suitable platform. The present invention may also be integrated as a tool into other software packages.

1. A method comprising the steps of:
for at least one OCR token (101, 201), determining a list of candidate interpretations (202), assigning a weighting to each of the candidate interpretations (103, 203), and ranking the list according to the weightings (104, 204); and
based on these rankings, generating document-specific information comprising document-specific OCR error pattern probabilities (105, 205), document-specific historical pattern probabilities (106, 206) and a document-specific frequency list (107, 207) of words associated with said document-specific patterns.

2. The method of claim 1, wherein the list of candidate interpretations is determined using a static lexicon (112, 212), and global information (108, 208) comprising probabilities of OCR error patterns (109, 209), probabilities of historical patterns (110, 210), and a frequency list (111, 211) of words associated with said patterns.

3. The method of claim 1, wherein the method is performed iteratively, wherein after the first iteration, the generated document-specific information is used to determine the list of candidate interpretations (102, 202).

4. The method of claim 2, wherein the method is performed iteratively, wherein the global information (108, 208) is updated with the document-specific information.

5. The method of claim 3 comprising, measuring the quality of the OCR output based on said document-specific information.

6. The method of claim 3 further comprising, indexing the OCR token (101, 201) with spelling variants of at least one word or word fragment based on said document-specific information.

7. The method of claim 3 wherein the method is for profiling historical spelling variants of words and OCR errors from the output of an optical character recognition system and is implemented by a computer.

8. The method of claim 7 wherein the OCR tokens are derived from at least one of a scanned input document and a re-keyed document.

9. A computer-implemented method for identifying historical spelling variants of words and OCR errors from the output of an optical character recognition system comprising the steps of:
for each electronic text representation of a word (101, 201) scanned from an input document, determining a list of possible interpretations (102, 202) including candidate words respectively associated with OCR error transformation patterns and historical variant transformation patterns, assigning a value to each of the interpretations (103, 203), and ordering the list in terms of the assigned values (104, 204);
determining a combined value for each type of pattern (105, 106, 205, 206) from said values assigned to each of the interpretations; and
based on said combined values (105, 106, 205, 206), deriving document-specific values (113, 213) including the probability of a the OCR error transformation pattern having occurred, the probability of the historical variant transformation pattern having occurred, and a list of the estimated number of times words considered to accord with current spelling appear in the input document based on the probability values.

10. The method of claim 9, wherein the value assigned to each of the interpretations is determined by summing the respective values for OCR error transformation patterns (105, 205) and historical variant transformation patterns (106, 206).

11. The method of claim 9, wherein the list of interpretations is determined using a static lexicon (112, 212), and global information (108, 208) comprising probability values of OCR error transformation patterns (109, 209), probability values of historical transformation patterns (110, 210), and a frequency list of words considered to accord with current spelling (111, 211), each word associated with one or more transformation patterns.

12. The method of claim 9, wherein the method is performed iteratively (114, 214), wherein after the first iteration, the derived document-specific probability values are used to determine the list of interpretations.

13. The method of claim 11, wherein the method is performed iteratively, wherein the global information is updated with the derived document-specific probability values.

14. The method of claim 12 comprising, measuring the quality of the OCR output based on said document-specific probability values.

15. The method of 9 comprising, indexing the electronic text representation with spelling variants of at least one word or word fragment based on said document-specific probability values.

16. A computer program product comprising:
a computer-readable storage medium having computer-executable program code portions stored therein for performing the method steps of:
for at least one OCR token (101, 201), determining a list of candidate interpretations (202), assigning a weighting to each of the candidate interpretations (103, 203), and ranking the list according to the weightings (104, 204); and
based on these rankings, generating document-specific information comprising document-specific OCR error pattern probabilities (105, 205), document-specific historical pattern probabilities (106, 206) and a document-specific frequency list (107, 207) of words associated with said document-specific patterns.

17. The computer program product of claim 16, wherein the method steps are performed iteratively, wherein after the first iteration, the generated document-specific information is used to determine the list of candidate interpretations (102, 202).
measuring the quality of the OCR output based on said document-specific information.

18. The computer program product of claim 17 comprising, measuring the quality of the OCR output based on said document-specific information.

19. The computer program product of claim 17 further comprising, indexing the OCR token (101, 201) with spelling variants of at least one word or word fragment based on said document-specific information.

20. The computer program product of claim 17, wherein the method is for profiling historical spelling variants of words and OCR errors from the output of an optical character recognition system and the OCR tokens are derived from at least one of a scanned input document and a re-keyed document.
